(19) United States
(12) Patent Application Publication
(10) Pub. No.: US 2005/0067550 A1
(43) Pub. Date: Mar. 31, 2005

(54) Plasma display device and chassis base thereof

(76) Inventors: Myoung-Kon Kim, Suwon-si (KR); Guy-Seong Kim, Suwon-si (KR)

Correspondence Address: CHRISTIE, PARKER & HALE, LLP, PO BOX 7068, PASADENA, CA, 91109-7068, US

(21) Appl. No.: 10/924,724

(22) Filed: Aug. 23, 2004

(30) Foreign Application Priority Data
Sep. 26, 2003 (KR) 2003-0066898

(51) Int. Cl. G09G 5/00

(52) U.S. Cl. 248/917

(57) ABSTRACT

A chassis base for supporting a display device is integrally formed with a plurality of stand supporters for receiving a stem of a stand.

### CROSS REFERENCE TO RELATED APPLICATION

This application claims priority to and the benefits of Korea Patent Application No. 2003-66898 filed on Sep. 26, 2003, in the Korean Intellectual Property offices, the entire content of which is incorporated herein by reference.

### FIELD OF THE INVENTION

Generally, the present invention relates to display devices and more particularly, an enhanced connecting structure of a chassis base and a stand for a plasma display device.

### BACKGROUND OF THE INVENTION

As is well known in the art, a plasma display device produces a desired image using a plasma discharge. Such a plasma display device generally includes a plasma display panel (PDP) for producing the desired image through a plasma discharge activated by an external power source, a chassis base for firmly holding the PDP at its front side, and circuit boards mounted on the rear side of the chassis base, for driving the PDP. Front and rear sides of a PDP module (i.e., a combination of a PDP, a chassis base, and circuit boards) are attached to front and rear cases to form the overall scheme of the plasma display device.

A plasma display device is usually provided with a stand such that a PDP module may stand upright while being manufactured, or so a finished plasma display device may be stored upright. For that purpose, the chassis base is usually designed to utilize such a stand.

According to the prior art, to assemble the stand with a chassis base, a stand guide for receiving the stand is separately produced and fastened to the chassis base. (i.e., through a screw-fastener). However, such a stand and a stand guide of the prior art are not convenient, as discussed below.

Production efficiency of the plasma display device may be enhanced either if the stand can be connected to the chassis base without introducing a separate stand guide, or if the process for fastening the stand guide to the chassis base becomes unnecessary.

In addition, it is notable that some types of plasma display devices, for example a plasma display device exclusively used for wall mounting, do not require such a stand in usage, while others do require a stand. Therefore, when different types of plasma display devices are manufactured in the same production line, unnecessary fastening or unfastening processes are frequently necessary.

Furthermore, according to the prior art, connected stands and stand guides frequently pull apart. Subsequently, the stand is typically fastened to the stand guide, which is firmly fixed to the chassis base. (i.e., by a screw-fastener). Therefore, a plasma display device may be produced through a simplified, more efficient production process when the process for fastening or unfastening the stand becomes unnecessary.

### SUMMARY OF THE INVENTION

In accordance with embodiments of the present invention, a plasma display device with enhanced production efficiency and a reduced production cost is provided.

An exemplary plasma display device according to an embodiment of the present invention includes a chassis base and a stand, wherein the chassis base can be mounted with a PDP and driving circuit, and has a base plate and a plurality of stand supporters integrally formed at the base plate. The stand can be connected to the plurality of stand supporters and includes a stand stem to connect the stand to the plurality of stand supporters and a bottom connected to the stand stem.

In a further embodiment, the chassis base is manufactured by pressing.

At least one supporter of the plurality of stand supporters may be formed during the pressing.

At least one supporter of the plurality of stand supporters may be formed after the pressing, by an additional process comprising bending or drawing.

In a still further embodiment, the plurality of stand supporters may include first, second, and third supporters consecutively arranged at a lower portion of the base plate. The third supporter being provided with a stem-receiving hole. The stand stem is inserted into the stem-receiving hole of the third supporter, and at least one supporter of the first and second supporters applies an elastic force to the stand stem in a direction opposite to the chassis base. In this case, a stopper may be formed at the first supporter, and an indentation for coupling with the stopper may be formed on a top of the stand stem.

In yet another embodiment, a catching projection for interacting with an interior of the stem-receiving hole is formed at the stand stem in the opposite direction of the chassis base, and the diameter of the stem-receiving hole is greater than the sum of a thickness of the stand stem and the height of the catching projection.

In a further embodiment, a threaded hole for engaging with a threaded bolt is formed at at least one of the first, second, and third supporters, and a penetration hole is formed at the stand stem at a position corresponding to the threaded hole.

The present invention also provides a chassis base for a plasma display device capable of being connected to a stand having a stand stem.

An exemplary chassis base according to an embodiment of the present invention includes a base plate and a plurality of stand supporters capable of being connected to the stand stem, the plurality of stand supporters are formed at the base plate.

In yet a further embodiment, the chassis base is manufactured by pressing.

At least one supporter of the plurality of stand supporters may be formed during the pressing.

At least one supporter of the plurality of stand supporters may be formed after the pressing, by an additional process comprising bending or drawing.

In a still further embodiment, the plurality of stand supporters comprises first, second, and third supporters consecutively arranged at a lower portion of the base plate. The third supporter contains a stem-receiving hole through which the stand stem may be inserted. Also, at least one supporter of the first and second supporters applies an elastic force to the stand stem in a direction opposite to the chassis base.

The first supporter may be provided with a stopper that is vertical to the aligning direction of the first, second, and third supporters such that the stopper may limit the maximum insertion depth of the stand stem through the stem-receiving hole.

A threaded hole for engaging with a threaded bolt may be formed at at least one of the first, second, and third supporters.

### BRIEF DESCRIPTION OF THE DRAWINGS

FIG. 1 is a perspective view of a chassis base of a plasma display device according to an embodiment of the present invention.

FIG. 2 is an enlarged perspective view of a portion A in FIG. 1.

FIG. 3 is an enlarged bottom view of a portion A in FIG. 1, i.e., a view seen along a direction A1 in FIG. 2.

FIG. 4 is a perspective view of a stand of a plasma display device according to an embodiment of the present invention.

FIG. 5 is a perspective view of a plasma display device according to an embodiment of the present invention, and illustrates an assembled structure of a chassis base and a stand.

FIG. 6 is an enlarged perspective view of a portion B in FIG. 5 seen along a direction B1.

FIG. 7 is an enlarged perspective view of a portion C in FIG. 5 seen along a direction C1.

FIG. 8 is a sectional view of FIG. 5 along a line VIII-VIII.

### DETAILED DESCRIPTION

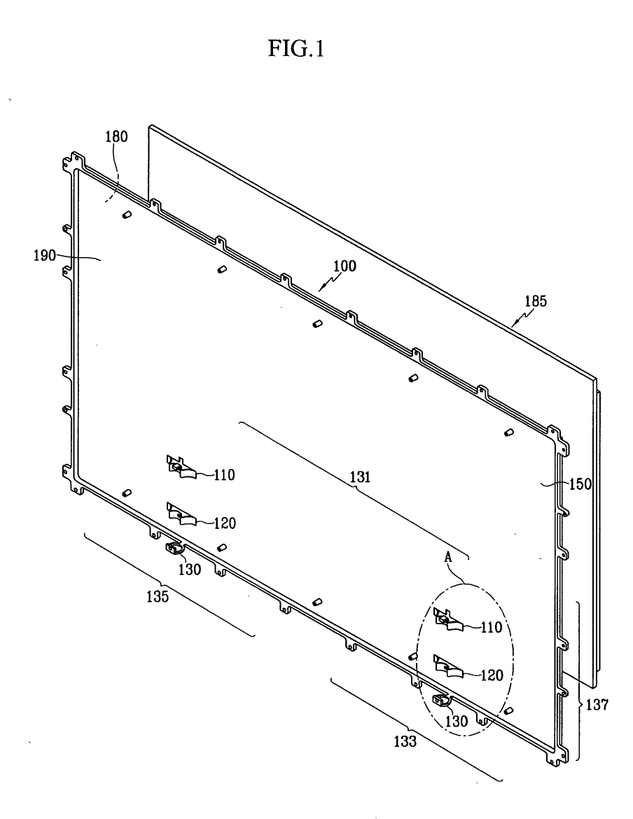

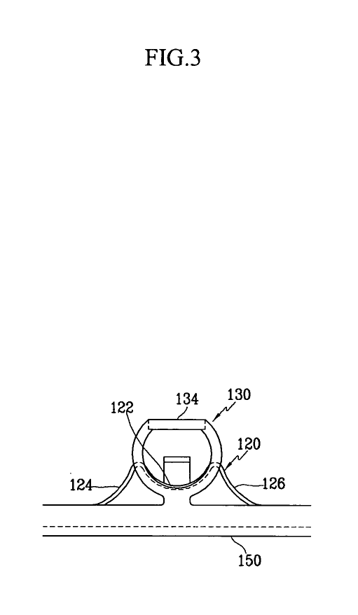

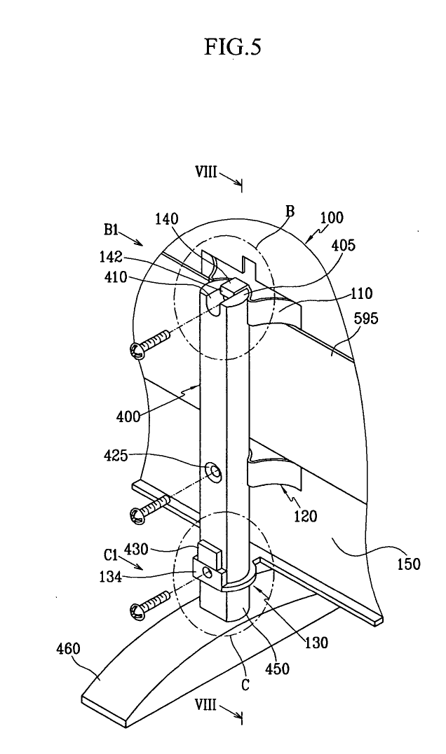

Referring to FIGS. 1-5, a plasma display device according to an embodiment of the present invention includes chassis base 100 and stand 400 connected to chassis base 100. PDP 185 is mounted to side 180 of chassis base 100, and driving circuit 595 (refer to FIG. 5) is mounted to an opposite side thereof. Chassis base 100 includes base plate 150 and a plurality of stand supporters integrally formed at base plate 150. According to an embodiment of the present invention, the plurality of stand supporters include first, second, and third supporters 110, 120, 130.

As shown in FIG. 1, first, second, and third supporters 110, 120, 130 are formed in pairs 131, adjacent to the chassis base 100. According to an embodiment of the present invention, each pair 131 of supporters 110, 120, 130 are formed symmetrically in left and right directions. Therefore, the plurality of supporters described in detail are first, second, and third supporters 110, 120, 130 formed on right side 133 of chassis base 100 and on left side 135 of chassis base 100.

Chassis base 100 may be manufactured in a variety of manners. (i.e., by pressing or die-casting). More specifically, chassis base 100 according to an embodiment of the present invention is manufactured by pressing. First, second, and third supporters 110, 120, 130 may be formed purely by pressing, or by an additional process including bending and/or drawing after pressing. Forming first, second, and third supporters 110, 120, 130 during press-manufacturing of chassis base 100 is described in further detail below.

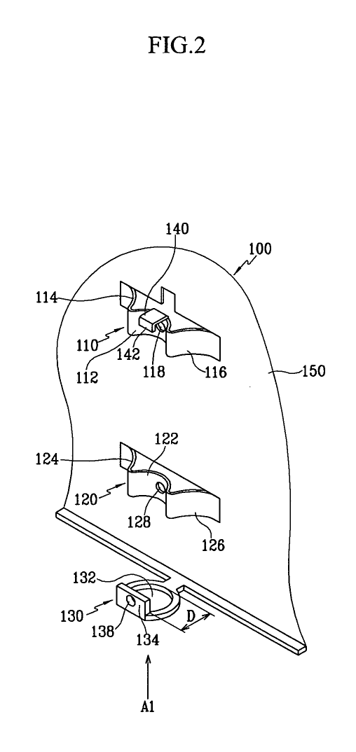

As shown in FIG. 1, first, second, and third supporters 110, 120, 130 are aligned at lower portion 137 of base plate 150. Features of first, second, and third supporters 110, 120, 130 are described in more detail below as well as referenced in FIG. 2.

Third supporter 130 is formed adjacent to lower end 137 of base plate 150. Stem-receiving hole 132 is provided at third supporter 130, such that stand 400 and chassis base 100 may be interconnected by inserting stem 450 of stand 400 through stem-receiving hole 132. Distal end 134 of third supporter 130 is vertically bent toward second supporter 120.

Second supporter 120 includes left and right walls 124, 126 rising from base plate 150, and concave portion 122 formed between left and right walls 124, 126. However, it is notable that the shape of concave portion 122 is not necessarily limited to an arc shape. To the contrary, the shape corresponds to stem 450 (refer to FIG. 5) of stand 400 that is connected to chassis base 100, as seen in FIG. 5.

In addition, it is notable that second supporter 120 provides elasticity since it is formed as an undulation of planar material used for base plate 150.

Just as with second supporter 120, first supporter 110 includes left and right walls 114, 116 rising from base plate 150, and concave portion 112 formed between left and right walls 114, 116. The description relating to concave portion 122 of second supporter 120 is also applicable to concave portion 112 of first supporter 110.

Stopper 140 is provided at first supporter 110, above concave portion 112 such that stopper 140 may limit a maximum insertion depth of stand stem 450 through stem-receiving hole 132. Stopper 140 projects from the top of concave portion 112, substantially vertical to the aligning direction of first, second, and third supporters 110, 120, 130. (i.e., substantially parallel to a plane of base plate 150). In addition, end 142 of stopper 140 is vertically bent toward second supporter 120.

First and second threaded holes 118, 128, which engage with a threaded bolt are formed at concave portions 112, 122 of first and second supporters 110, 120. Bolt receiving hole 138 is formed at distal end 134 bent from third supporter 130 such that a threaded bolt may project therethrough.

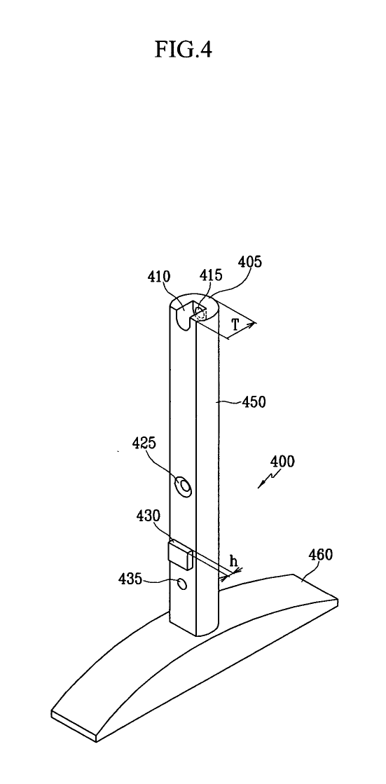

Stand 400 of a plasma display device according to an embodiment of the present invention is described in further detail with reference to FIG. 4. Stand 400 includes stem 450, which connects to first, second, and third supporters 110, 120, 130 and thereby connects to chassis base 100, and bottom 460 connects to stem 450. Indentation 410 for coupling with end 142 of stopper 140 of first supporter 110 is formed on top 405 of stand stem 450. At stem 450, first and second penetration holes 415, 425 are formed at positions corresponding to first and second threaded holes 118, 128, and third threaded hole 435 is formed at a position corresponding to bolt receiving hole 138. Catching projection 430, which interacts with the interior of stem-receiving hole 132 of third supporter 130 (i.e., the distal end 132 of the third supporter 130) is formed at stand stem 450 in the opposite direction of chassis base 100 (i.e., on the same side as the indentation 410). When inserted through stem-receiving hole 132 of third supporter 130, stem 450 may remain at the inserted position because catching projection 430 is caught by distal end 132 of third supporter 130.

Referring both to FIGS. 2 and 4, width D of stem-receiving hole 132 in a direction adjacent to base plate 150 is slightly wider than the sum of thickness T of stem 450 and projection height h of catching projection 430. Therefore, stem 450 of stand 400 may form a clearance with stem-receiving hole 132. However, due to the elasticity of second supporter 120, stem 450 in stem-receiving hole 132 experiences an abutting force away from base plate 150. Due to such an interaction with catching projection 430, stem 450 inserted can remain stable at its inserted position. When stand 400 is required to be removed from chassis base 100, it can be easily removed by pushing bottom 460 of stand 400 toward chassis base 100 by more than height h of catching projection 430 and then drawing it out. Taking into account such an assembling/disassembling mechanism of stand 400 and chassis base 100, projection height h of catching projection 430 is set at 0.5 mm according to an embodiment of the present invention. However, it is notable that projection height h of such a catching projection may be varied in accordance with various factors such as specific shapes of first, second, and third supporters 110, 120, 130, material, and/or thickness of base plate 150.

As has been already described, chassis base 100 may be manufactured in a variety of manners. (i.e., by pressing or die-casting). More specifically, chassis base 100 according to an embodiment of the present invention is manufactured by pressing. Second supporter 120 may be naturally formed through piercing during the pressing process. First supporter 110 may also be formed through piercing during a pressing process, and finished by forming stopper 140 through bending and/or drawing. Regarding forming of third supporter 130, stem receiving hole 132 is formed through piercing during a pressing process, and then third supporter 130 is bent vertically to base plate 150. Finally, end 134 of stem-receiving hole 132 is formed by drawing.

The above described forming processes of first, second, and third supporters 110, 120, 130 should be understood as the exemplary embodiment. However, first, second, and third supporters 110, 120, 130 may be formed in various other manners. Therefore, the scope of the present invention should not be understood as being limited to specific forming process of first, second, and third supporters 110, 120, 130.

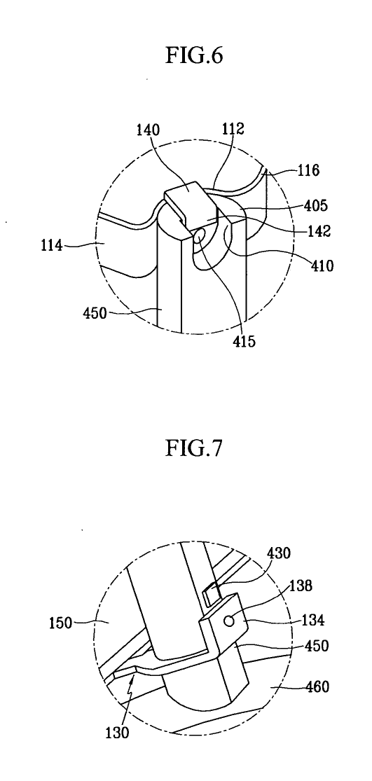

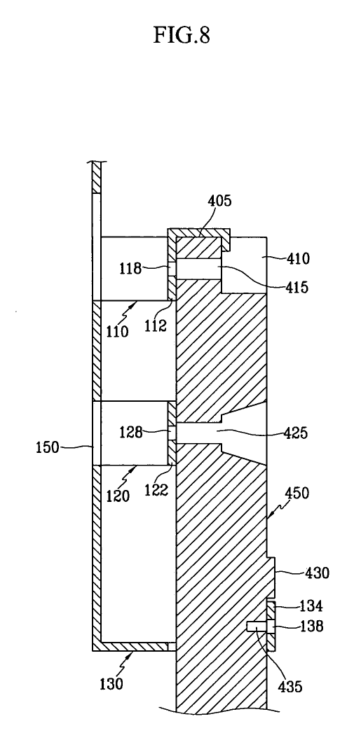

An assembled structure of chassis base 100 and stand 400 according to another embodiment of the present invention is described in detail with reference to FIGS. 5-8.

Stem 450 of stand 400 is forwardly inserted through stem-receiving hole 132 of third supporter 130. Upon insertion, stem 450 comes to lie on concave portion 122 of second supporter 120, and top 405 of stem 450 comes to lie on concave portion 112 of first supporter 110. An insertion depth of stem 450 is limited because forward movement of top 405 of stem 450 is limited by stopper 140 of first supporter 110. In this case, end 142 of stopper 140 is inserted into indentation 410 on top 405 of stem 450. Thus, preventing rotation of stem 450. When stem 450 is maximally inserted through stem-receiving hole 132 of third supporter 130, stem 450 is prevented from escaping stem-receiving hole 132 because of the interaction between catching projection 430 of stem 450 and distal end 134 of third supporter 130. Therefore, stand 400 may stably remain at its position assembled with chassis base 100, without introducing a structural element separate from chassis base 100 or without necessitating a preliminary process such as attaching a structural element to chassis base 100.

According to still another embodiment of the present invention, for more reliable conjunction of stand 400 to chassis base 100, threaded bolts are engaged with first threaded hole 118 through first penetration hole 415, second threaded hole 128 through second penetration hole 425, and third threaded hole 435 through bolt receiving hole 138.

According to yet another embodiment of the present invention, a stand and a chassis base may remain assembled without needing an additional structural element for connecting them because a supporter for receiving a stand is formed at a base plate of the chassis base. Accordingly, a process for mounting the additional structural element to the chassis base becomes unnecessary. Thus, manufacturing of the plasma display device is simplified. In addition, a required number of parts for manufacturing the plasma display device is reduced and therefore manufacturing costs are reduced.

Furthermore, unlike the prior art whose additional structural element consumes substantial space to provide sufficient strength for firmly supporting the stand, the supporters in accordance with the present invention form at the chassis base and consume minimal space to provide such strength. Therefore, spatial usage of the chassis base may be enhanced according to an embodiment of the present invention.

For example, the space consumption of the present embodiment of the invention may be reduced to 38 mm (height of a stand may be reduced as such) without deteriorating structural strength of the assembly of the chassis base and the stand, while the prior art consumes a space of 51 mm to achieve the same structural strength.

Furthermore, taking into account that a circuit board may be mounted in the space between supporters, a person of ordinary skill in the art would agree that the spatial usage of the plasma display device according to the embodiment of the present invention has been greatly enhanced over the prior art.

When the chassis base is manufactured by pressing, the qualities of the present invention become more prevalent.

Malfunction of the stand may be prevented by attaching the catching projection of the stand to the supporter of the chassis base.

Rotation of the stand may be prevented by the interaction of the stopper of the supporter with the indentation at the top of the stand stem.

While this invention has been described in connection with what is presently considered to be practical, exemplary embodiments, it is to be understood that the invention is not limited to the disclosed embodiments, but, to the contrary, is intended to cover various modifications and equivalent arrangements included within the spirit and scope of the appended claims.

1. An apparatus for supporting a display device comprising:
a chassis base mountable with a display panel and a driving circuit, the chassis base comprising a base plate and a plurality of stand supporters integrally formed at the base plate; and
a stand connectable to the plurality of stand supporters, the stand comprising a stand stem for being connected to the plurality of stand supporters and a bottom connected to the stand stem.

2. The apparatus for supporting a display device of claim 1, wherein the chassis base is manufactured by pressing.

3. The apparatus for supporting a display device of claim 2, wherein at least one supporter of the plurality of stand supporters is formed during pressing.

4. The apparatus for supporting a display device of claim 2, wherein at least one supporter of the plurality of stand supporters is formed after pressing, by an additional process comprising bending or drawing.

5. The apparatus for supporting a display device of claim 2, wherein:
the plurality of stand supporters comprises first, second, and third supporters consecutively arranged at a lower portion of the base plate;
the third supporter is provided with a stem-receiving hole;
the stand stem is inserted into the stem-receiving hole of the third supporter; and
at least one supporter of the first and second supporters applies an elastic force to the stand stem in a direction opposite to the chassis base.

6. The apparatus for supporting a display device of claim 5, wherein a stopper is formed at the first supporter, and an indentation for coupling with the stopper is formed on a top of the stand stem.

7. The apparatus for supporting a display device of claim 5, wherein:
a catching projection for interacting with an interior of the stem-receiving hole is formed at the stand stem in the opposite direction of the chassis base; and
the diameter of the stem-receiving hole is greater than the sum of the thickness of the stand stem and the height of the catching projection.

8. The apparatus for supporting a display device of claim 5, wherein:
a threaded hole for engaging with a threaded bolt is formed at at least one of the first, second, and third supporters; and
a penetration hole is formed at the stand stem at a position corresponding to the threaded hole.

9. A chassis base for an apparatus for supporting a display device connectable to a stand having a stand stem, the chassis base comprising:
a base plate; and
a plurality of stand supporters capable of being connected to the stand stem, the plurality of stand supporters being integrally formed at the base plate.

10. The chassis base of claim 9, wherein the chassis base is manufactured by pressing.

11. The chassis base of claim 10, wherein at least one supporter of the plurality of stand supporters is formed during the pressing.

12. The chassis base of claim 10, wherein at least one supporter of the plurality of stand supporters is formed after the pressing, by an additional process comprising bending or drawing.

13. The chassis base of claim 10, wherein:
the plurality of stand supporters comprises first, second, and third supporters consecutively arranged at a lower portion of the base plate;
the third supporter is provided with a stem-receiving hole through which the stand stem may be inserted; and
at least one supporter of the first and second supporters applies an elastic force to the stand stem in a direction opposite to the chassis base.

14. The chassis base of claim 13, wherein the first supporter is provided with a stopper projected substantially adjacent with respect to the aligning direction of the first, second, and third supporters, the stopper defining the maximum insertion depth of the stand stem through the stem-receiving hole.

15. The chassis base of claim 13, wherein a threaded hole for engaging with a threaded bolt is formed at at least one of the first, second, and third supporters.

16. The chassis base of claim 9, wherein the display device is a plasma display device.

17. The apparatus for supporting a display device of claim 1, wherein the display panel is a plasma display panel.
